(19) United States
(12) Patent Application Publication
(10) Pub. No.: US 2025/0216046 A1
(43) Pub. Date: Jul. 3, 2025

(54) VEHICLE LAMP OPTICAL ELEMENT, VEHICLE LAMP MODULE, AND VEHICLE

(71) Applicant: Anhui Senhai vision technology Co., LTD, Hefei (CN)

(72) Inventors: Chun YANG, Hefei (CN); Jianfeng DING, Hefei (CN)

(73) Assignee: Anhui Senhai vision technology Co., LTD, Hefei (CN)

(21) Appl. No.: 18/886,000

(22) Filed: Sep. 16, 2024

Related U.S. Application Data
(63) Continuation of application No. PCT/CN2024/116512, filed on Sep. 3, 2024.

(30) Foreign Application Priority Data
Dec. 27, 2023 (CN) 202311845754.2

(51) Int. Cl. F21S 41/32; F21S 41/24; F21W 102/135

(52) U.S. Cl. CPC F21S 41/321; F21S 41/24; F21W 2102/135

(57) ABSTRACT

Embodiments of the specification disclose a vehicle lamp optical element, a vehicle lamp module, and a vehicle, and belongs to the technical field of vehicle lamps. A solution may include: a vehicle lamp optical element, including one or more optical units, where a front end of the optical unit is provided with a light emitting surface, a rear end thereof is provided with a light receiving structure, the light receiving structure includes a light incident surface and a reflecting surface, the light receiving structure is configured to reflect light that is incident from the light incident surface through the reflecting surface and then form an intermediate light image at a focal plane of the light emitting surface, and the light emitting surface is configured to image the intermediate light image to a front of the vehicle lamp optical element.

### CROSS-REFERENCE TO RELATED APPLICATIONS

The application claims priority to Chinese patent application No. 202311845754.2, filed on Dec. 27, 2023, the entire contents of which are incorporated herein by reference.

### TECHNICAL FIELD

The present application relates to the technical field of vehicle illumination, and in particular, to a vehicle lamp optical element, a vehicle lamp module, and a vehicle.

### BACKGROUND

At present, in addition to a lamp panel, a driver, and a bracket, a common vehicle lamp module usually includes a plurality of components such as an outer lens and a light receiving structure (including a solution of a reflective bowl and a lens), and components such as a cutoff line baffle need to be additionally disposed when a light shape needs a cutoff line. A large quantity of parts in the vehicle lamp module results in a large overall size, and a structure is complex, so that more tolerances (including an error of a single part and an error of assembly) are introduced, and yield is reduced. In addition, more materials and assembly links caused by a plurality of parts also result in higher production costs.

### SUMMARY

Embodiments of the specification provide a vehicle lamp optical element, a vehicle lamp module, and a vehicle and are used to provide a vehicle lamp optical element with a simple structure, high efficiency, and a small size, to reduce manufacturing difficulty and costs of the vehicle lamp module, improve manufacturing and assembly precision of the vehicle lamp module, and provide more probabilities for diversified styles of a vehicle lamp.

To solve the above technical problem, the embodiments of the specification are implemented as follows:

The embodiments of the specification provide a vehicle lamp optical element, where the vehicle lamp optical element includes one or more optical units 100; and a front end of the optical unit 100 is provided with a light emitting surface 1, a rear end thereof is provided with a light receiving structure 2, the light receiving structure 2 includes a light incident surface 21 and a reflecting surface 22, the light receiving structure 2 is configured to reflect light that is incident from the light incident surface 21 through the reflecting surface 22 and then form an intermediate light image at a focal plane of the light emitting surface 1, and the light emitting surface 1 is configured to image the intermediate light image to a front of the vehicle lamp optical element.

Optionally, the light receiving structure 2 further includes a first cutoff line structure located on the reflecting surface 22, and the first cutoff line structure is configured to destroy a local reflection effect of the reflecting surface 22; and at least one focal point of the light emitting surface 1 is located at the first cutoff line structure.

Optionally, the light receiving structure 2 further includes a cutting surface 23 formed by cutting the reflecting surface 22, and a shape of a first boundary line 201 between the reflecting surface 22 and the cutting surface 23 is adapted to a shape of a light shape cutoff line.

Optionally, the reflecting surface 22 of the light receiving structure 2 includes a first region 221 whose outer side is coated with a highly-absorbent material and a second region 222 whose outer side is coated with a highly-reflective material, and a shape of a border line 202 between the first region 221 and the second region 222 is adapted to a shape of a light shape cutoff line.

Optionally, the optical unit 100 further includes a first splicing portion 3 located at a rear end of the light receiving structure 2, the first splicing portion 3 is made of a nontransparent material, and a shape of a second boundary line 203 between a splicing interface that is formed between the first splicing portion 3 and the light receiving structure 2 and the reflecting surface 22 is adapted to a shape of a light shape cutoff line.

Optionally, the optical unit 100 further includes a second cutoff line structure located downstream of the reflecting surface 22 on a light path, and the second cutoff line structure is configured to block partial light emitted from the reflecting surface 22 to the light emitting surface 1; and at least one focal point of the light emitting surface 1 is located at the second cutoff line structure.

Optionally, the second cutoff line structure includes a groove 4 located in a region of a lower side surface of the optical unit 100; and the groove 4 includes a first side surface 41 close to the light receiving structure 2 and a second side surface 42 away from the light receiving structure 2, and a shape of a third boundary line 401 between the first side surface 41 and the second side surface 42 is adapted to a shape of a light shape cutoff line.

Optionally, the optical unit 100 may further include a second splicing portion 5 located in the groove 4, and the second splicing portion 5 is made of a nontransparent material.

Optionally, at least one of the first side surface 41 and the second side surface 42 is coated with a highly-absorbent material or a highly-reflective material.

Optionally, the second cutoff line structure is disposed at a position adjacent to the light receiving structure 2.

Optionally, an outer side of the reflecting surface 22 is coated with a reflective coating.

Optionally, an outer side of the reflecting surface 22 is provided with a reflective mirror 6 that is adjacent to the reflecting surface 22 and that has a contour consistent with that of the reflecting surface 22.

Embodiments of the specification provide a vehicle lamp optical element, where the vehicle lamp optical element includes one or more optical unit groups 200; the optical unit group 200 includes a first optical unit 210 and a second optical unit 220 that are disposed along a light path in sequence; a rear end of the first optical unit 210 is provided with a light receiving structure 2, and a front end thereof is provided with a first light emitting surface 7; a rear end of the second optical unit 220 is provided with a second light incident surface 8, and a front end thereof is provided with a second light emitting surface 9; and the light receiving structure 2 includes a light incident surface 21 and a reflecting surface 22, the light receiving structure 2 is configured to reflect light that is incident from the light incident surface 21 through the reflecting surface 22 and then form an intermediate light image at a joint focal plane of the first light emitting surface 7, the second light incident surface 8, and the second light emitting surface 9, and the first light emitting surface 7 and the second optical unit 220 are configured to image the intermediate light image to a front of the vehicle lamp optical element.

Optionally, the first light emitting surface 7 is configured to control lateral distribution of light.

Optionally, the first light emitting surface 7 includes one or more optical surfaces configured to adjust the propagation direction of the light in a left-right direction.

Optionally, the first light emitting surface 7, the second light incident surface 8, and the second light emitting surface 9 are configured to jointly control vertical distribution of the light.

Optionally, at least one of the first light emitting surface 7, the second light incident surface 8, and the second light emitting surface 9 includes one or more optical surfaces configured to adjust a propagation direction of the light in an up-down direction.

Optionally, the first optical unit 210 and the second optical unit 220 are integrally formed.

Optionally, a connecting structure 230 is formed between the first optical unit 210 and the second optical unit 220.

Optionally, the light receiving structure 2 further includes a first cutoff line structure located on the reflecting surface 22, and the first cutoff line structure is configured to destroy a local reflection effect of the reflecting surface 22; focal points of the first light emitting surface 7 in a left-right direction are located at the first cutoff line structure; and focal points of the first light emitting surface 7, the second light incident surface 8, and the second light emitting surface 9 in an up-down direction are located at the first cutoff line structure.

Optionally, the light receiving structure 2 may further include a cutting surface 23 formed by cutting the reflecting surface 22, and a shape of a first boundary line 201 between the reflecting surface 22 and the cutting surface 23 is adapted to a shape of a light shape cutoff line; or optionally, the reflecting surface 22 of the light receiving structure 2 includes a first region 221 whose outer side is coated with a highly-absorbent material and a second region 222 whose outer side is coated with a highly-reflective material, and a shape of a border line 202 between the first region 221 and the second region 222 is adapted to a shape of a light shape cutoff line; or optionally, the first optical unit 210 further includes a first splicing portion 3 located at a rear end of the light receiving structure 2, the first splicing portion 3 is made of a nontransparent material, and a shape of a second boundary line 203 between a splicing interface that is formed between the first splicing portion 3 and the light receiving structure 2 and the reflecting surface 22 is adapted to a shape of a light shape cutoff line.

Optionally, the first optical unit 210 further includes a second cutoff line structure located downstream of the reflecting surface 22 on a light path, and the second cutoff line structure is configured to block partial light emitted from the reflecting surface 22 to the first light emitting surface 7; focal points of the first light emitting surface 7 in a left-right direction are located at the second cutoff line structure; and focal points of the first light emitting surface 7, the second light incident surface 8, and the second light emitting surface 9 in an up-down direction are located at the second cutoff line structure.

Optionally, the second cutoff line structure includes a groove 4 located in a region of a lower side surface of the first optical unit 210; and the groove 4 includes a first side surface 41 close to the light receiving structure 2 and a second side surface 42 away from the light receiving structure 2, and a shape of a third boundary line 401 between the first side surface 41 and the second side surface 42 is adapted to a shape of a light shape cutoff line.

Optionally, the first optical unit 210 further includes a second splicing portion 5 located in the groove 4, and the second splicing portion 5 is made of a nontransparent material; or optionally, at least one of the first side surface 41 and the second side surface 42 is coated with a highly-absorbent material or a highly-reflective material.

Optionally, the second cutoff line structure is disposed at a position adjacent to the light receiving structure 2.

Optionally, an outer side of the reflecting surface 22 is coated with a reflective coating; or optionally, an outer side of the reflecting surface 22 is provided with a reflective mirror 6 that is adjacent to the reflecting surface 22 and that has a contour consistent with that of the reflecting surface 22.

Embodiments of the specification provide a vehicle lamp module, including the vehicle lamp optical element provided in the embodiments of the specification.

Embodiments of the specification provide a vehicle, including the vehicle lamp module provided in the embodiments of the specification.

An embodiment of the specification at least can achieve the beneficial effects as follows: a vehicle lamp optical element including one or more optical units is disposed, where a front end of the optical unit is provided with a light emitting surface, a rear end thereof is provided with a light receiving structure, the light receiving structure includes a light incident surface and a reflecting surface, the light receiving structure is configured to reflect light that is incident from the light incident surface through the reflecting surface and then form an intermediate light image at a focal plane of the light emitting surface, and the light emitting surface is configured to image the intermediate light image to a front of the vehicle lamp optical element. Therefore, a size of the vehicle lamp optical element can be reduced, and a vehicle lamp illumination function can be implemented in manners of simple structure, high efficiency, and small size, thereby reducing manufacturing costs and improving manufacturing and assembly precision of the vehicle lamp module. In addition, a smaller size of the vehicle lamp optical element realizes a higher degree of freedom in overall lamp style design, which reduces design difficulty of an overall lamp structure and realizes an aesthetic appearance.

### BRIEF DESCRIPTION OF THE DRAWINGS

To describe the technical solutions in the embodiments of the specification or in the prior art more clearly, the following briefly introduces the accompanying drawings required for describing the embodiments or the prior art. Apparently, the accompanying drawings in the following description show merely some embodiments of the present application, and those of ordinary skill in the art may still derive other drawings from these accompanying drawings without creative efforts.

FIG. 1 is a three-dimensional diagram of a vehicle lamp optical element (an optical unit) provided by an embodiment of the specification;

FIG. 2 is a three-dimensional diagram of a vehicle lamp optical element (an optical unit) with a cutoff line structure provided by an embodiment of the specification;

FIG. 3 is another three-dimensional diagram of a vehicle lamp optical element (an optical unit) with a cutoff line structure provided by an embodiment of the specification;

FIG. 4 is a three-dimensional diagram of a vehicle lamp optical element including a plurality of optical units provided by an embodiment of the specification;

FIG. 5 is a three-dimensional layout diagram of a vehicle lamp optical element including a plurality of optical units provided by an embodiment of the specification;

FIG. 6 is a longitudinal-sectional view of a vehicle lamp optical element (an optical unit) provided by an embodiment of the specification;

FIG. 7 is a schematic longitudinal-sectional view of a vehicle lamp optical element provided with a reflective mirror provided by an embodiment of the specification;

FIG. 8 is a schematic position diagram in which a first cutoff line structure is disposed in a vehicle lamp optical element provided by an embodiment of the specification;

FIG. 9 is a schematic partial three-dimensional diagram of a vehicle lamp optical element provided with a first cutoff line structure provided by an embodiment of the specification;

FIG. 10 is another schematic partial three-dimensional diagram of a vehicle lamp optical element provided with a first cutoff line structure provided by an embodiment of the specification;

FIG. 11 is still another schematic partial three-dimensional diagram of a vehicle lamp optical element provided with a first cutoff line structure provided by an embodiment of the specification;

FIG. 12 is yet another schematic partial longitudinal-sectional view of a vehicle lamp optical element provided with a first cutoff line structure provided by an embodiment of the specification;

FIG. 13 is a schematic position diagram in which a second cutoff line structure is disposed in a vehicle lamp optical element provided by an embodiment of the specification;

FIG. 14 is a schematic partial three-dimensional diagram of a vehicle lamp optical element provided with a second cutoff line structure provided by an embodiment of the specification;

FIG. 15 is a schematic partial longitudinal-sectional view of a vehicle lamp optical element provided with a second cutoff line structure provided by an embodiment of the specification;

FIG. 16 is another schematic partial longitudinal-sectional view of a vehicle lamp optical element provided with a second cutoff line structure provided by an embodiment of the specification;

FIG. 17 is a schematic structural diagram of a light emitting surface of a vehicle lamp optical element provided by an embodiment of the specification;

FIG. 18 is another schematic structural diagram of a light emitting surface of a vehicle lamp optical element provided by an embodiment of the specification;

FIG. 19 is a three-dimensional diagram of a vehicle lamp optical element (an optical unit group) provided by an embodiment of the specification;

FIG. 20 is a three-dimensional diagram of a vehicle lamp optical element (an optical unit group) with a cutoff line structure provided by an embodiment of the specification;

FIG. 21 is another three-dimensional diagram of a vehicle lamp optical element (an optical unit group) with a cutoff line structure provided by an embodiment of the specification;

FIG. 22 is a longitudinal-sectional view of a vehicle lamp optical element (an optical unit group) provided by an embodiment of the specification;

FIG. 23 is a cross-sectional view of a vehicle lamp optical element (an optical unit group) provided by an embodiment of the specification;

FIG. 24 is a three-dimensional diagram of a vehicle lamp optical element including a plurality of optical unit groups provided by an embodiment of the specification;

FIG. 25 is a cross-sectional view of a vehicle lamp optical element shown in FIG. 24 provided by an embodiment of the specification;

FIG. 26 is another three-dimensional diagram of a vehicle lamp optical element including a plurality of optical unit groups provided by an embodiment of the specification;

FIG. 27 is still another three-dimensional diagram of a vehicle lamp optical element including a plurality of optical unit groups provided by an embodiment of the specification;

FIG. 28 is a longitudinal-sectional view of a vehicle lamp optical element shown in FIG. 27 provided by an embodiment of the specification;

FIG. 29 is yet another three-dimensional diagram of a vehicle lamp optical element including a plurality of optical unit groups provided by an embodiment of the specification; and

FIG. 30 is a cross-sectional view of a vehicle lamp optical element shown in FIG. 29 provided by an embodiment of the specification.

Reference numerals in the accompanying drawings: 100—optical unit; 1—light emitting surface; 11—optical lens surface; 12—non-optical step surface; 2—light receiving structure; 21—light incident surface; 22—reflecting surface; 221—first region; 222—second region; 23—cutting surface; 201—first boundary line; 202—border line; 203—second boundary line; 3—first splicing portion; 4—groove; 41—first side surface; 42—second side surface; 401—third boundary line; 5—second splicing portion; 6—reflective mirror; 200—optical unit group; 210—first optical unit; 220—second optical unit; 7—first light emitting surface; 8—second light incident surface; 9—second light emitting surface; 230—connecting structure.

### DETAILED DESCRIPTION OF THE EMBODIMENTS

To make the objectives, technical solutions, and advantages of one or more embodiments of the specification clearer, the following clearly and completely describes the technical solutions in the one or more embodiments of the specification with reference to the specific embodiments of the specification and the corresponding accompanying drawings. Apparently, the embodiments described are merely some rather than all of the embodiments of the specification. Based on the embodiments in the specification, all other embodiments obtained by those of ordinary skill in the art without making creative labor should fall within the scope of protection of the one or more embodiments of the specification.

The structures, proportions, sizes, and the like shown in the drawings of the specification are only used to coordinate with the content disclosed herein for the understanding and reading of those skilled in the art rather than to limit the conditions under which the present invention can be implemented. Therefore, they have no technically substantive significance, and any structural modifications, changes in proportions, or adjustments in sizes should still fall within the scope of the technical content disclosed herein without affecting the effectiveness and objectives of the present invention.

It should be noted that, in the description of the specification, the terms “first” and “second” are used for descriptive purposes only and should not be construed as indication or implication of relative importance. Unless otherwise specified, “a plurality of” refers to two or more. The terms “central”, “longitudinal”, “lateral”, “up”, “down”, “front”, “back”, “left”, “right”, “vertical”, “horizontal”, “top”, “bottom”, “inside”, “outside”, and the like are based on those shown in the accompanying drawings, intended only for the convenience of describing the embodiments of the present invention and for simplifying the description, and not intended to indicate or imply that the referred apparatus or element must be provided with a particular orientation or constructed and operated with a particular orientation, therefore not allowed to be construed as a limitation of the present invention.

In the following description, directions/orientations such as up, down, left, right, front (front end), and rear (rear end) are all based on a vehicle driving position.

Destruction in the specification may be interpreted as an elimination effect in the processes of reflection, refraction, and the like of light, for example, a destruction effect of a cutoff line structure is to eliminate local reflection of a reflecting surface. (cutoff line)

Adaptation in the specification may be interpreted as that the adapted two belong to a proportional zoom-in or zoom-out relationship, for example, a shape of a first boundary line 201 between the reflecting surface 22 and the cutting surface 23 is adapted to a shape of a light shape cutoff line, which may be interpreted as that the shape of the first boundary line 201 and the shape of the light shape cutoff line are of the proportional zoom-in or zoom-out relationship.

At present, to make a style of a vehicle lamp more novel, one of improvements is to design a lamp to be flatter. However, according to the flat vehicle lamp style, a higher requirement is also provided for a size of an illumination module. That is, the size of the illumination module needs to be designed to be smaller on the premise that an optical performance requirement is met.

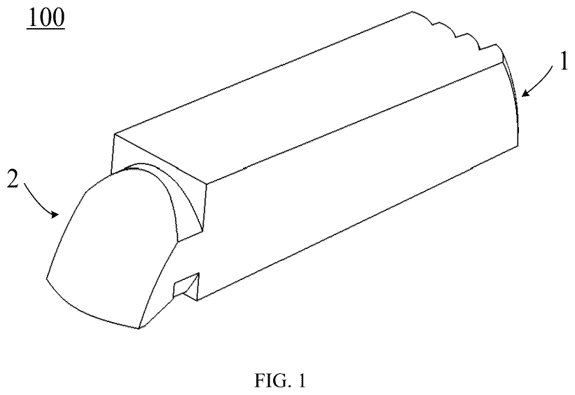

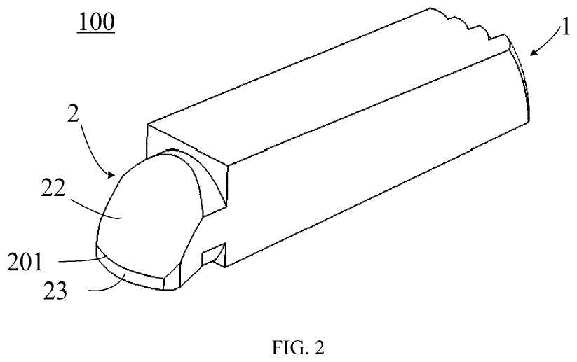

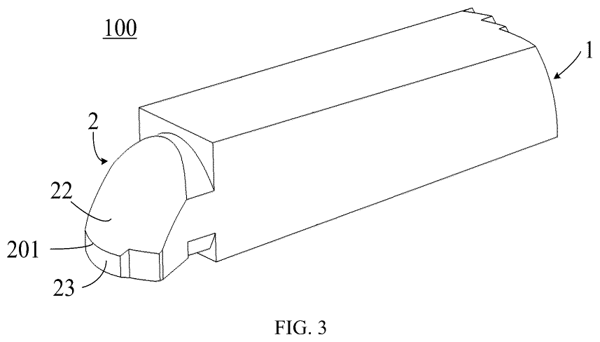

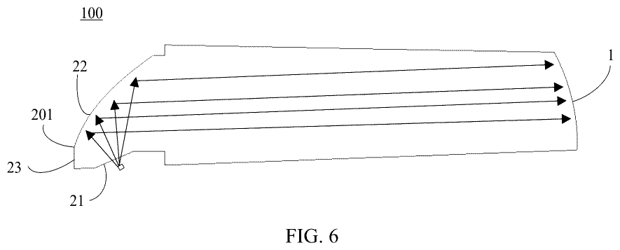

In embodiments of the specification, as shown in FIG. 1 to FIG. 6, a vehicle lamp optical element is provided, where the vehicle lamp optical element includes one or more optical units 100; and a front end of the optical unit 100 is provided with a light emitting surface 1, a rear end thereof is provided with a light receiving structure 2, the light receiving structure 2 includes a light incident surface 21 and a reflecting surface 22, the light receiving structure 2 is configured to reflect light that is incident from the light incident surface 21 through the reflecting surface 22 and then form an intermediate light image at a focal plane of the light emitting surface 1, and the light emitting surface 1 is configured to image the intermediate light image to a front of the vehicle lamp optical element. For example, FIG. 6 is a longitudinal-sectional view of a vehicle lamp optical element (an optical unit 100) corresponding to FIG. 2 or FIG. 3 provided by an embodiment of the specification, and specifically, schematically shows a propagation direction of light.

The vehicle lamp optical element may be made of a transparent light guide material. Optionally, the transparent light guide material may include PMMA, PC, glass, or the like, which is not limited thereto.

The light incident surface 21, the reflecting surface 22, and the light emitting surface 1 are disposed along a light path in sequence. The light incident surface 21 is close to a light source and collects light, and the reflecting surface 22 performs secondary light distribution on light emitted by the light source, so that the light is converged at the light emitting surface 1 and then is emitted to form a light shape. During actual application, the vehicle lamp optical element (the optical unit 100) may form a target light shape or a part of the target light shape in a traffic space in front of a vehicle provided with a vehicle lamp module including the vehicle lamp optical element.

The light incident surface 21 may be a smooth surface, for example, may be a plane, a convex curved surface, or a concave curved surface. During actual application, the light incident surface 21 may also be configured as an applicable pattern surface.

During actual application, a distance between the light source and the light receiving structure 2 may be configured as small as possible, to improve light efficiency. For example, the distance between the light source and the light receiving structure 2 may be configured to be less than 5 mm. Optionally, the light source may specifically be an LED light source or a laser light source.

In addition, in a case that the vehicle lamp optical element includes a plurality of optical units 100, optionally, the plurality of optical units 100 may be integrally formed to obtain the vehicle lamp optical element; or optionally, the plurality of optical units 100 may be separately formed and then spliced to obtain the vehicle lamp optical element.

Specifically, in a case that the vehicle lamp optical element includes a plurality of optical units 100, the plurality of optical units 100 may be integrally formed or spliced according to an actual requirement. During actual application, a quantity of optical units 100 actually included in the vehicle lamp optical element may be determined according to requirements of luminous flux and optical performance.

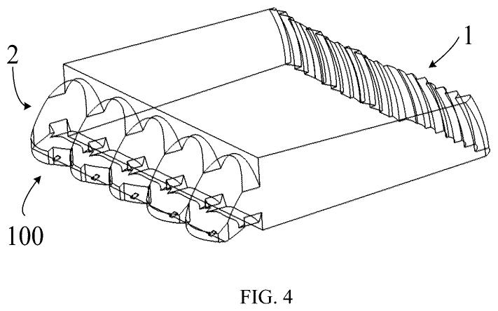

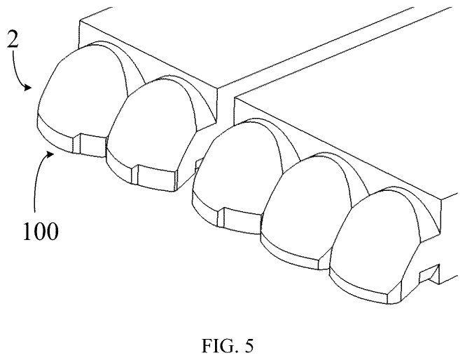

For example, FIG. 4 shows an example of an integrally formed vehicle lamp optical element including five optical units 100. For another example, FIG. 5 shows a vehicle lamp optical element jointly composed of an integrally formed first portion including two optical units 100 and an integrally formed second portion including three optical units 100.

It may be understood that a combination manner of the plurality of optical units 100 may be configured according to an actual requirement and does not need to be limited to a grouping condition exemplarily shown in the foregoing FIG. 4 and FIG. 5. In addition, relative positions between different groups shown in FIG. 5 are merely exemplary, and during actual application, the plurality of optical units 100 may not only be combined into a lateral row style shown in FIG. 4 and FIG. 5, but also may be combined into various styles such as a vertical row, a C shape, and an L shape, to meet a requirement of an overall lamp style.

In the embodiments of the specification, although sizes of a front end and a rear end of the optical unit 100 shown in the accompanying drawings are generally consistent, a shape of the optical unit 100 is not limited to the examples shown in the accompanying drawings.

Optionally, a shape of a longitudinal section, perpendicular to a front-rear direction, of the optical unit 100 may be any shape, for example, a rectangle, a trapezoid (which is isosceles or non-isosceles), an inverted trapezoid (which is isosceles or non-isosceles), a rhombus, and another shape. During actual application, an upper side and a lower side of the optical unit 100 may be aequilate or non-aequilate.

Optionally, sizes of a plurality of longitudinal sections, perpendicular to the front-rear direction, of the optical unit 100 may be the same or different. For example, an area of a longitudinal section, close to a light emitting side, of a light passing body portion of the optical unit 100 may be equal to or less than an area of a longitudinal section close to a light incident side. During actual application, an opening size of a light emitting side at the front end of the optical unit 100 may be less than or equal to a size of a light incident opening at the rear end of the optical unit 100. The size of the light emitting side is configured to be less than the size of the light incident side, which helps reduce an overall size of the optical unit 100.

Based on the solutions in the embodiments of the specification, the optical unit 100 is an integrally formed element, which replaces a vehicle lamp optical assembly including at least a plurality of parts such as a light receiving structure and an outer lens in the prior art, has lower material costs, and can reduce assembly links, reduce assembly difficulty, and improve a production speed. Meanwhile, fewer parts have fewer component tolerances and assembly tolerances, so that manufacturing and assembly precision of the vehicle lamp module and stability of product quality and performance can be improved while manufacturing costs are reduced.

Compared with a conventional solution, based on the vehicle lamp optical element including one or more optical units 100 provided in the embodiments of the specification, at least one focal point of the light emitting surface 1 in the optical unit 100 is located at the reflecting surface 22 or close to the reflecting surface 22, so that a length in the front-rear direction of the vehicle lamp optical element composed of the optical unit 100 is greatly reduced. In addition, a quantity of refracting surfaces through which light passes is reduced, the light is transmitted inside a medium, and light utilization efficiency is higher. Therefore, a structure is simple and efficiency is high, and a light channel and the light emitting surface can be configured to be smaller. Therefore, based on the vehicle lamp optical element provided in the embodiments of the specification, a smaller element size can realize a higher degree of freedom in overall lamp style design, which reduces design difficulty of an overall lamp structure and realizes an aesthetic appearance.

At present, a height of a common vehicle lamp optical assembly in the market is usually more than 25 mm, and a height and a width of the light emitting surface 1 of the optical unit provided in the embodiments of the specification can be within 5 mm, which is much less than a size of a conventional solution in the market. A smaller light emitting surface makes a space occupied by the vehicle lamp optical element smaller and more aesthetic, can reduce design difficulty of overall lamp structure, and realizes a higher degree of freedom in overall lamp style design.

In at least a part of the embodiments of the specification, the light receiving structure 2 may be configured to collect light emitted by the light source and then converge the light to the light emitting surface 1 by using the reflecting surface 22.

The reflecting surface 22 may be a continuous curved surface. The reflecting surface 22 may be a curved surface protruding toward the rear end. More specifically, the reflecting surface 22 may be configured to enable light projected on the reflecting surface to converge to a certain degree in a left-right direction and an up-down direction. During actual application, when the vehicle lamp optical element includes a plurality of optical units 100, reflection angles and convergence degrees for light of any two of the plurality of optical units 100 may be different, that is, may be configured according to an actual light shape design requirement.

The reflecting surface 22 may be a total reflecting surface. That is, light is incident on the reflecting surface 22 at an angle greater than a critical angle, basically only light reflection occurs on the reflecting surface 22, and basically no light refraction occurs.

During actual application, according to an application principle of the vehicle lamp optical element, a target light pattern is obtained by projecting a light spot (the light spot is obtained through intersection of the focal plane and a light beam) at a focal plane by an optical system (for example, the light emitting surface 1). A shape of the light spot at the focal plane is an important influence factor affecting a shape of the target light pattern; and energy distribution at the focal plane is an important factor affecting brightness distribution of the target light pattern. In addition, a light intensity maximum point is required on the brightness distribution of the target light pattern according to regulation requirements of light distribution of the vehicle lamp. During actual application, how to ensure even improve the light intensity maximum point of the target light pattern while reducing the size of the vehicle lamp optical element is crucial, which is a key problem of manufacturing a vehicle lamp optical element with a small size.

In the embodiments of the specification, to reduce the size of the vehicle lamp optical element, a reflection structure of a side light incident type is used. However, due to characteristics of the reflection structure, it is determined that energy distribution at the reflecting surface 22 is non-uniform, so that energy distribution at a focal plane at an adjacent position is non-uniform. This is because a region (for example, a region of a lower left side of the reflecting surface 22 shown in FIG. 6 to FIG. 16), closer to the light source, of the reflecting surface 22 receives stronger energy, but the region closer to the light source is more difficult to meet conditions of total internal reflection theorem. In view of this, it is difficult to rely on a reflection effect of a material of the reflecting surface 22 to reflect sufficient light to pass through the light emitting surface 1 to contribute to light intensity.

In the embodiments of the specification, to implement the light intensity maximum point on the brightness distribution of the target light pattern, an outer side of the reflecting surface 22 may be coated with a reflective coating or a conformal reflective mirror may be added. In this case, the light emitting surface 1 may be configured to enable a focal point of the light emitting surface to fall in a region (for example, a region of a lower left side of the reflecting surface 22 shown in FIG. 6 to FIG. 16) with relatively high light intensity of the reflecting surface 22, and a relatively large light intensity maximum point in the target light pattern may be obtained by using the reflective coating or the conformal reflective mirror.

Optionally, the outer side of the reflecting surface 22 may be coated with the reflective coating, to enhance reflection performance of the reflecting surface 22, thereby improving light utilization efficiency.

During actual application, a material used to form the reflective coating may include aluminum, silver, stainless steel, chromium, and the like, which is not limited thereto. In addition, during actual application, the reflective coating may be formed through processes such as spraying, vacuum plating, hot stamping, and in-mold injection molding, which is not limited thereto.

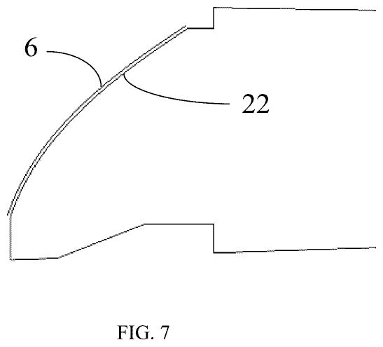

Optionally, as shown in FIG. 7, the outer side of the reflecting surface 22 may be provided with a reflective mirror 6 that is adjacent to the reflecting surface 22 and that has a contour consistent with that of the reflecting surface 22, to enhance reflection performance of the optical unit 100, thereby improving light utilization efficiency. A uniform gap may be formed between the reflecting surface 22 and the reflective mirror 6.

During actual application, the reflective mirror 6 may be configured to be close to the reflecting surface 22 as much as possible. For example, the reflective mirror 6 may be glued to the outer side of the reflecting surface 22 through a lens gluing process. At this time, the gap between the reflecting surface 22 and the reflective mirror 6 may be filled with a transparent adhesive. For another example, the reflective mirror 6 may be fixed to the outer side of the reflecting surface 22 through a support structure. At this time, a uniform air gap may be formed between the reflecting surface 22 and the reflective mirror 6.

Based on the vehicle lamp optical element (the optical unit 100) provided in the embodiments of the specification, a light shape without a cutoff line may be provided, for example, FIG. 1. FIG. 1 is a three-dimensional diagram of a vehicle lamp optical element (an optical unit) provided by an embodiment of the specification, where a cutoff line structure is not disposed. During actual application, the vehicle lamp optical element (the optical unit 100) shown in FIG. 1 may be applied to a high beam.

In at least a part of the embodiments of the specification, the cutoff line structure may further be disposed in the optical unit 100, to be configured to form a light shape with a cutoff line, for example, FIG. 2 and FIG. 3. FIG. 2 is a three-dimensional diagram of a vehicle lamp optical element (an optical unit) with a cutoff line structure provided by an embodiment of the specification, where the cutoff line structure is disposed, and specifically, a shape of a first boundary line 201 between the reflecting surface 22 and a cutting surface 23 may be adapted to a shape of a light shape cutoff line. FIG. 3 is another three-dimensional diagram of a vehicle lamp optical element (an optical unit) with a cutoff line structure provided by an embodiment of the specification, where the cutoff line structure is disposed, and specifically, a shape of a first boundary line 201 between the reflecting surface 22 and a cutting surface 23 may be adapted to a shape of a light shape cutoff line. During actual application, the vehicle lamp optical element (the optical unit 100) shown in FIG. 2 or FIG. 3 may be applied to a low beam, a front fog lamp, a corner lamp, a steering auxiliary illumination lamp, or the like.

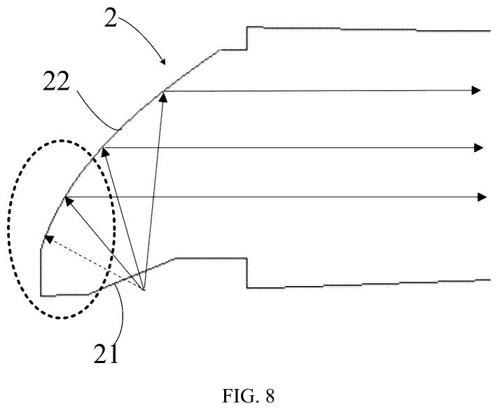

The following describes the cutoff line structure with reference to FIG. 8 to FIG. 16. In the embodiments of the specification, the cutoff line structure (including a first cutoff line structure and a second cutoff line structure) may specifically refer to a structure configured to form a light shape cutoff line in a light shape.

In an optional embodiment, the light receiving structure 2 may further include the first cutoff line structure located on the reflecting surface 22, and the first cutoff line structure is configured to destroy a local reflection effect of the reflecting surface 22. Specifically, the first cutoff line structure may be configured to prevent partial light emitted toward the reflecting surface 22 from being reflected.

A focal point of the light emitting surface 1 (referring to FIG. 2 and FIG. 3) may be located at the first cutoff line structure, for example, may be located near the first cutoff line structure. In addition, during actual application, when the light emitting surface 1 has a plurality of focal points, at least one focal point of the light emitting surface 1 may be located near the first cutoff line structure. Therefore, a clear cutoff line can be formed in the light shape.

As shown in FIG. 8, an elliptical dashed box identifies a region where the first cutoff line structure is formed, that is, a region whose reflection effect is destroyed of the reflecting surface 22. In addition, in FIG. 8, the light incident surface 21 is shown. In addition, light shown in a dashed line in FIG. 8 may represent light that is cut off by the first cutoff line structure.

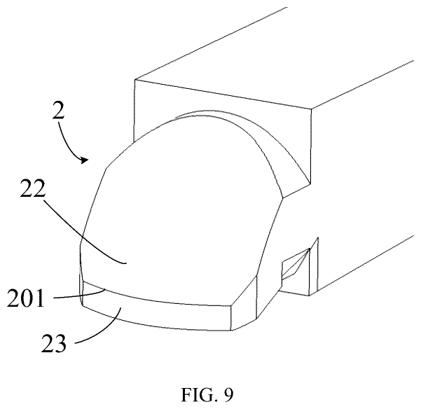

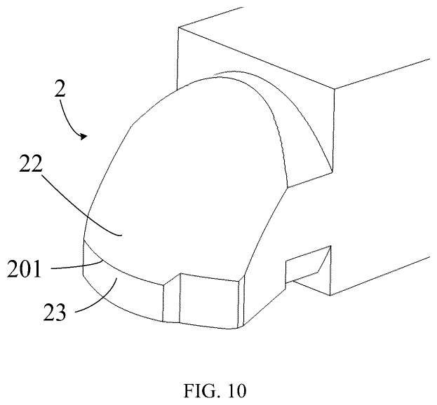

As an optional example, referring to FIG. 9 and FIG. 10, the light receiving structure 2 may further include a cutting surface 23 formed by cutting the reflecting surface 22, and a shape of a first boundary line 201 between the reflecting surface 22 and the cutting surface 23 is adapted to a shape of a light shape cutoff line. At least one focal point of the light emitting surface 1 (referring to FIG. 2 and FIG. 3) may be located at the first boundary line 201, for example, may be located on or near the first boundary line 201.

Optionally, as shown in FIG. 9, the cutting surface 23 may extend along a straight line or a smooth curve in a left-right direction, and the cutting surface 23 may be a plane or a smooth curved surface. Therefore, a projection (that is, a projection of the first boundary line 201 on a surface perpendicular to a main optic axis of the light emitting surface 1) of the first boundary line 201 between the cutting surface 23 and the reflecting surface 22 may be a straight line. During actual application, when the vehicle lamp optical element is applied to the front fog lamp or the steering auxiliary illumination lamp (the corner lamp), the cutoff line in the light shape may be a horizontal line.

Optionally, as shown in FIG. 10, the cutting surface 23 may extend along a line with an inflection point in a left-right direction, and the cutting surface 23 may be a surface including a step. Therefore, a projection (that is, a projection of the boundary line on a surface perpendicular to a main optic axis of the light emitting surface 1) of the first boundary line 201 between the cutting surface 23 and the reflecting surface 22 may be a line with an inflection point. During actual application, when the vehicle lamp optical element is applied to the low beam, the cutoff line in the light shape may be a line with an inflection point.

During actual application, the cutting surface 23 may also be directly formed when the optical unit 100 is integrally formed, or may be formed by cutting through a subsequent processing process after the optical unit 100 is formed.

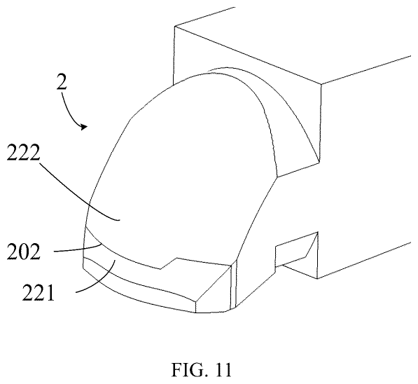

As another optional example, referring to FIG. 11, the reflecting surface 22 of the light receiving structure 2 includes a first region 221 whose outer side is coated with a highly-absorbent material and a second region 222 whose outer side is coated with a highly-reflective material, and a shape of a border line 202 between the first region 221 and the second region 222 is adapted to a shape of a light shape cutoff line. At least one focal point of the light emitting surface 1 (referring to FIG. 2 and FIG. 3) may be located at the border line 202, for example, may be located on or near the border line 202.

Optionally, the border line 202 may be a smooth straight line or curve extending in a left-right direction, and a projection (that is, a projection of the border line 202 on a surface perpendicular to a main optic axis of the light emitting surface 1) of the border line may be a straight line; or optionally, the border line 202 may be a smooth folding line extending in a left-right direction, and a projection (that is, a projection of the border line 202 on a surface perpendicular to a main optic axis of the light emitting surface 1) of the border line may be a line with an inflection point.

The highly-reflective material coated on the first region 221 may include aluminum, silver, stainless steel, chromium, and the like, which is not limited thereto. The highly-absorbent material coated on the second region 222 may include black paint, the black paint may include, for example, pigment (for example, carbon black, iron oxide, and titanium dioxide), solvent (for example, a desiccant, a thinner, and a preservative), and resin (for example, a desiccant, a thinner, and a preservative), and may further include additives (for example, a desiccant, a thinner, and a preservative) and the like. The example of the black paint is not limited thereto, and the example of the highly-absorbent material is not limited to the black paint.

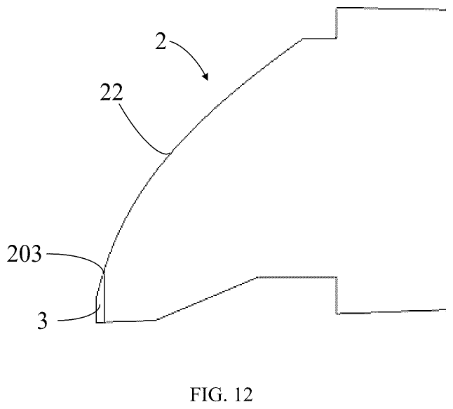

As another optional example, referring to FIG. 12, the optical unit 100 further includes a first splicing portion 3 located at a rear end of the light receiving structure 2, the first splicing portion 3 is made of a nontransparent material, and a shape of a second boundary line 203 between a splicing interface that is formed between the first splicing portion 3 and the light receiving structure 2 and the reflecting surface 22 is adapted to a shape of a light shape cutoff line. At least one focal point of the light emitting surface 1 (referring to FIG. 2 and FIG. 3) may be located at the second boundary line 203, for example, may be located on or near the second boundary line 203.

Optionally, the second boundary line 203 may be a smooth straight line or curve extending in a left-right direction, and a projection (that is, a projection of the second boundary line 203 on a surface perpendicular to a main optic axis of the light emitting surface 1) of the second boundary line may be a straight line; or optionally, the second boundary line 203 may be a smooth folding line extending in a left-right direction, and a projection (that is, a projection of the second boundary line 203 on a surface perpendicular to a main optic axis of the light emitting surface 1) of the second boundary line may be a line with an inflection point.

The nontransparent material constituting the first splicing portion 3 may include a black PC (polycarbonate) material, a black PMMA (polymethyl methacrylate) material, and the like, which is not limited thereto.

During actual application, the first splicing portion 3 may be formed in a process of integrally forming the optical unit 100; or optionally, the first splicing portion 3 may be formed through a subsequent process after a main portion of the optical unit 100 is integrally formed.

In an optional embodiment, the optical unit 100 may further include a second cutoff line structure located downstream of the reflecting surface 22 on a light path, and the second cutoff line structure may be configured to block partial light emitted from the reflecting surface 22 to the light emitting surface 1 (referring to FIG. 2 and FIG. 3).

A focal point of the light emitting surface 1 (referring to FIG. 2 and FIG. 3) may be located at the second cutoff line structure, for example, may be located near the second cutoff line structure. In addition, during actual application, when the light emitting surface 1 has a plurality of focal points, at least one focal point of the light emitting surface 1 may be located near the second cutoff line structure. Therefore, a clear cutoff line can be formed in the light shape.

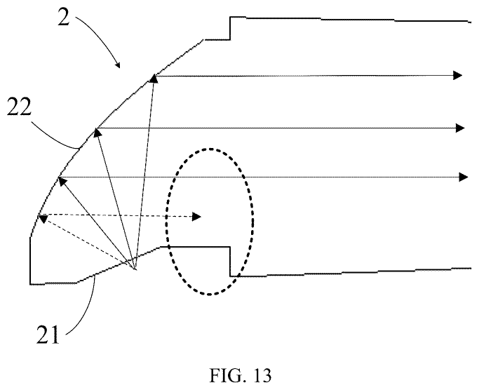

In actual application, to configure a length of the optical unit 100 to be relatively small, the second cutoff line structure may be disposed at a position adjacent to the light receiving structure 2. As shown in FIG. 13, an elliptical dashed box identifies a region where the second cutoff line structure is formed, and the region is preferably a position located downstream of the light receiving structure 2 (located downstream of the reflecting surface 22 on the light path) and adjacent to the light receiving structure 2 in the optical unit 100. Light shown in a dashed line in FIG. 13 may represent light that is cut off by the second cutoff line structure.

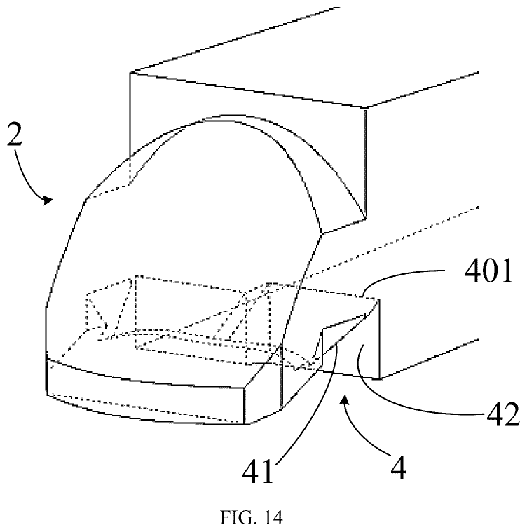

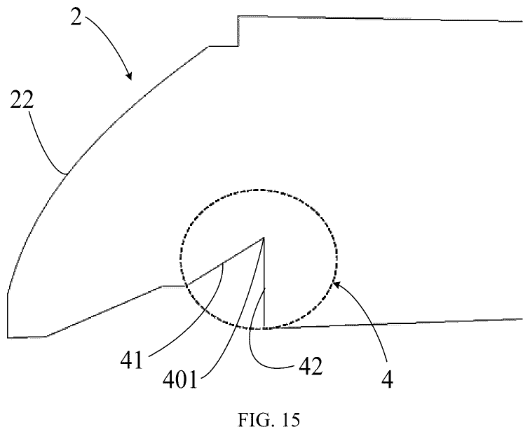

As an optional example, referring to FIG. 14 and FIG. 15, the second cutoff line structure may include a groove 4 located in a region of a lower side surface of the optical unit 100; and the groove 4 may include a first side surface 41 close to the light receiving structure 2 and a second side surface 42 away from the light receiving structure 2, and a shape of a third boundary line 401 between the first side surface 41 and the second side surface 42 is adapted to a shape of a light shape cutoff line. At least one focal point of the light emitting surface 1 (referring to FIG. 2 and FIG. 3) may be located at the third boundary line 401, for example, may be located on or near the third boundary line 401.

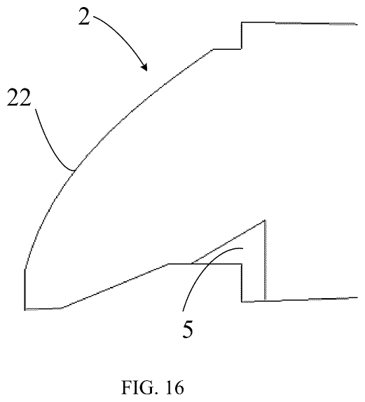

As another optional example, referring to FIG. 16, the optical unit 100 may further include a second splicing portion 5 located in the groove 4, and the second splicing portion 5 is made of a nontransparent material. The nontransparent material constituting the second splicing portion 5 may include a black PC (polycarbonate) material, a black PMMA (polymethyl methacrylate) material, and the like, which is not limited thereto.

During actual application, the second splicing portion 5 may be formed in a process of integrally forming the optical unit 100; or optionally, the second splicing portion 5 may be formed through a subsequent process after a main portion of the optical unit 100 is integrally formed.

As still another optional example, at least one of the first side surface 41 and the second side surface 42 is coated with a highly-absorbent material or a highly-reflective material. The highly-reflective material may include aluminum, silver, stainless steel, chromium, and the like, which is not limited thereto. The highly-absorbent material may include black paint, the black paint may include, for example, pigment (for example, carbon black, iron oxide, and titanium dioxide), solvent (for example, a desiccant, a thinner, and a preservative), and resin (for example, a desiccant, a thinner, and a preservative), and may further include additives (for example, a desiccant, a thinner, and a preservative) and the like. The example of the black paint is not limited thereto, and the example of the highly-absorbent material is not limited to the black paint. During actual application, the first side surface 41 and the second side surface 42 may not be coated with any material, and an effect of blocking the light path is implemented only through angle adjustment; and the highly-absorbent material or the highly-reflective material may further improve a light blocking effect.

Optionally, the first side surface 41 and the second side surface 42 may extend along a straight line or a smooth curve in a left-right direction, and the first side surface 41 and the second side surface 42 may be a plane or a smooth curved surface. Therefore, a projection (that is, a projection of the third boundary line 401 on a surface perpendicular to a main optic axis of the light emitting surface 1) of the third boundary line 401 between the first side surface 41 and the second side surface 42 may be a straight line. During actual application, when the vehicle lamp optical element is applied to the front fog lamp or the steering auxiliary illumination lamp (the corner lamp), the cutoff line in the light shape may be a horizontal line.

Optionally, as shown in FIG. 14, as can be seen in a portion shown in dashed lines through perspective, the first side surface 41 and the second side surface 42 may extend along a line with an inflection point in a left-right direction, and the first side surface 41 and the second side surface 42 may be a surface including a step. Therefore, a projection (that is, a projection of the boundary line on a surface perpendicular to a main optic axis of the light emitting surface 1) of the third boundary line 401 between the first side surface 41 and the second side surface 42 may be a line with an inflection point. During actual application, when the vehicle lamp optical element is applied to the low beam, the cutoff line in the light shape may be a line with an inflection point.

Based on the above one or more embodiments of the specification, through a vehicle lamp optical element obtained by arranging and combining the plurality of optical units 100, a high beam light shape or a low beam light shape may be formed in a traffic space in front of a vehicle provided with a vehicle lamp module including the corresponding vehicle lamp optical element. Optionally, the vehicle lamp optical element in the embodiments of the specification may further be configured as a front fog lamp, a corner lamp, or a steering auxiliary illumination lamp.

In at least a part of the embodiments of the specification, in the provided vehicle lamp optical element, optionally, the light emitting surface 1 of the optical unit 100 may be a continuous curved surface. During actual application, the continuous curved surface may be a revolution curved surface, and the revolution curved surface may include a spherical surface or an aspherical surface.

Alternatively, optionally, the light emitting surface 1 of the optical unit 100 may be a step pattern surface, and the step pattern surface may include a plurality of optical lens surfaces 11 and non-optical step surfaces 12 connecting the plurality of optical lens surfaces 11.

Optionally, to implement a target light shape effect, focal points of the plurality of optical lens surfaces 11 may overlap with each other or get close to each other. When the vehicle lamp optical element includes the cutoff line structure, to implement a relatively clear light shape cutoff line, a focal point of at least one optical lens surface 11 of the plurality of optical lens surfaces 11 may be located near the cutoff line structure.

During actual application, the step pattern surface may include a step Fresnel square pattern, a step Fresnel vertical stripe, a step Fresnel horizontal stripe, a step Fresnel rhombic pattern, a step Fresnel polygonal pattern, a step Fresnel special-shaped stripe, and the like, and a type of the step pattern surface is not limited to the examples listed herein.

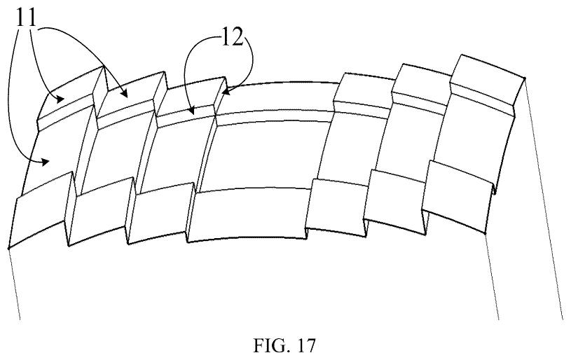

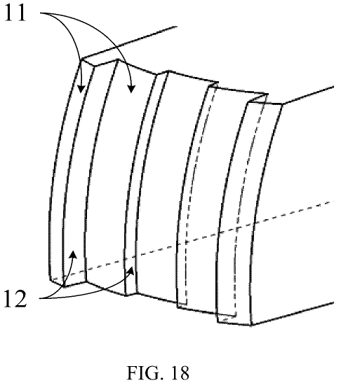

As an example, as shown in FIG. 17, the step Fresnel square pattern is shown. In FIG. 17, the plurality of optical lens surfaces 11 are of square shapes and arranged in a staggered checkerboard form, and adjacent optical lens surfaces 11 are connected through the non-optical step surface 12. As shown in FIG. 18, the step Fresnel vertical stripe is shown. In FIG. 18, the plurality of optical lens surfaces 11 are of vertical strip shapes and arranged in a staggered side-by-side form, and adjacent optical lens surfaces 11 are connected through the non-optical step surface 12.

In addition, in an optional embodiment, a contour of the light emitting surface 1 may

be arbitrarily configured according to a design requirement. For example, the contour may be of a square shape, a round shape, or any other shape.

In addition, in an optional embodiment, the light emitting surface 1 may further be provided with a microstructural pattern, to adjust a cutoff line gradient.

In at least a part of the embodiments of the specification, the provided vehicle lamp optical element may include a low-beam three-region structure, configured to form a low-beam three-region light shape in the target light shape of the vehicle lamp optical element, to enable the vehicle lamp optical element to meet requirements of regulatory three regions.

Specifically, the low-beam three-region structure may be disposed on an upper surface and/or a lower surface of the vehicle lamp optical element (the optical unit 100). Optionally, the low-beam three-region structure may include a first low-beam three-region structure, and the first low-beam three-region structure may be configured as an outward protruding structure or an inward recessed structure on the upper surface of the optical unit 100. Optionally, the low-beam three-region structure may include a second low-beam three-region structure, and the second low-beam three-region structure may be configured as an outward protruding structure or an inward recessed structure on the lower surface of the optical unit 100.

In addition, in an optional embodiment, a coating and/or a pattern may be added on an upper side surface and/or a lower side surface of the optical unit 100. Therefore, system stray light can be optimized.

In addition, in an optional embodiment, the upper side surface and the lower side surface of the vehicle lamp optical element provided in the embodiments of the specification may be configured to be hidden in a decorative frame or protrude from a decorative frame according to an actual style requirement.

It should be noted that not all embodiments of the present application are shown in the accompanying drawings, and a person skilled in the art may obtain more embodiments of the present application according to a combination of the features described in the specification. For example, although an example in which the light emitting surface 1 is the step Fresnel vertical stripe is used in FIG. 1 to FIG. 4, a person skilled in the art may understand that the continuous curved surface or another type of step pattern surface is also feasible. For another example, although a chamfer angle is not shown between the reflecting surface and the light incident surface of the vehicle lamp optical element (the optical unit) shown in FIG. 1, it can be understood that, in actual application, a chamfered surface may exist between the reflecting surface and the light incident surface due to a manufacturing process and other reasons. The examples given herein are not exhaustive.

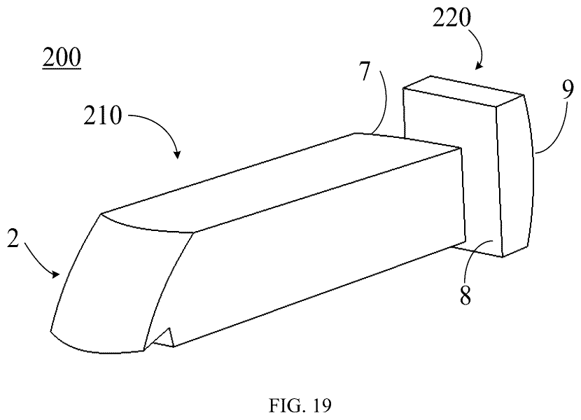

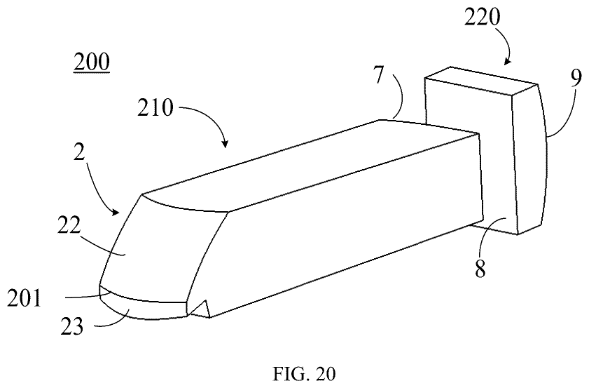

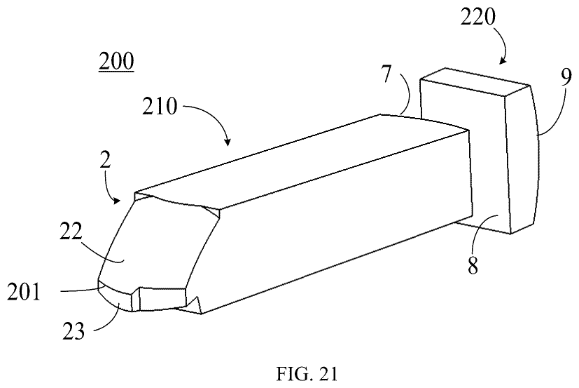

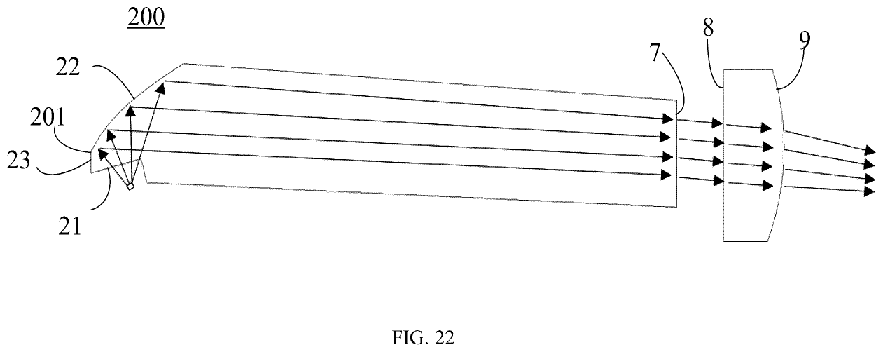

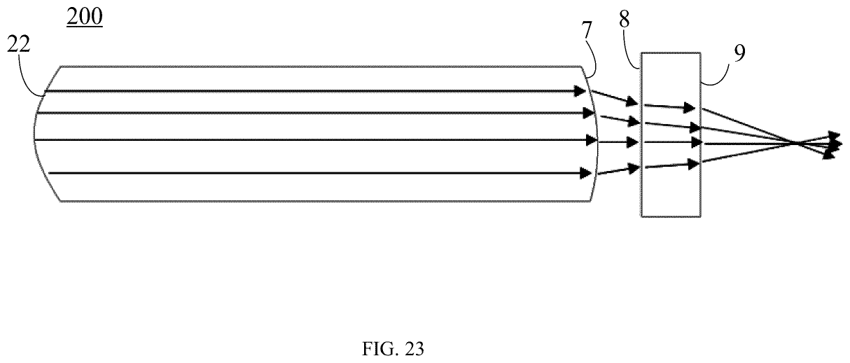

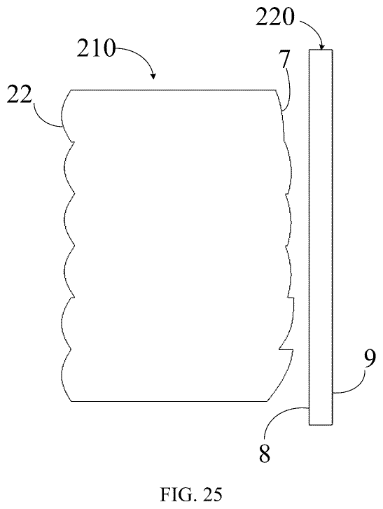

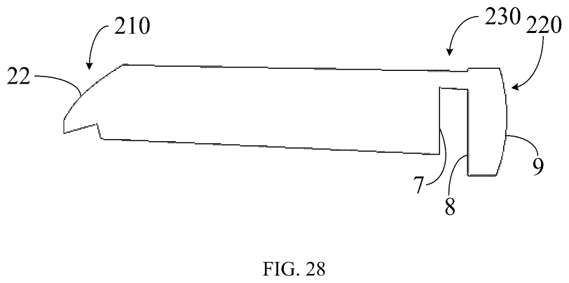

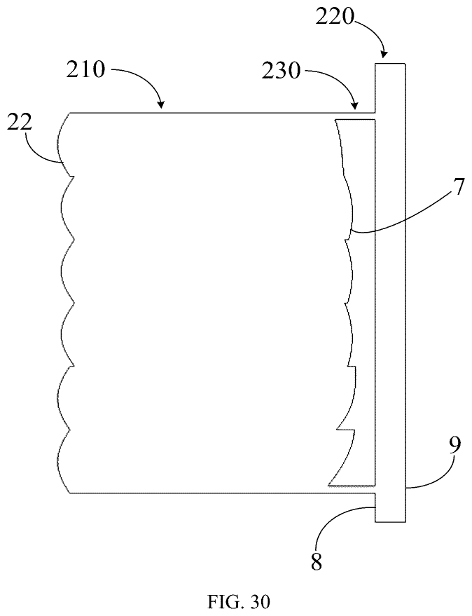

In another embodiment of the specification, as shown in FIG. 19 to FIG. 30, a vehicle lamp optical element is provided, where the vehicle lamp optical element includes one or more optical unit groups 200; the optical unit group 200 includes a first optical unit 210 and a second optical unit 220 that are disposed along a light path in sequence; a rear end of the first optical unit 210 is provided with a light receiving structure 2, and a front end thereof is provided with a first light emitting surface 7; a rear end of the second optical unit 220 is provided with a second light incident surface 8, and a front end thereof is provided with a second light emitting surface 9; and the light receiving structure 2 includes a light incident surface 21 and a reflecting surface 22, the light receiving structure 2 is configured to reflect light that is incident from the light incident surface 21 through the reflecting surface 22 and then form an intermediate light image at a joint focal plane of the first light emitting surface 7, the second light incident surface 8, and the second light emitting surface 9, and the first light emitting surface 7 and the second optical unit 220 are configured to image the intermediate light image to a front of the vehicle lamp optical element. FIG. 22 is a longitudinal-sectional view of a vehicle lamp optical element (an optical unit group 200) corresponding to FIG. 20 or FIG. 21 provided by an embodiment of the specification. FIG. 23 is a cross-sectional view of a vehicle lamp optical element (an optical unit group 200) corresponding to FIG. 19, FIG. 20, or FIG. 21 provided by an embodiment of the specification. In addition, specifically, FIG. 22 and FIG. 23 schematically show a propagation direction of light in the vehicle lamp optical element (the optical unit group 200).

In the embodiments of the specification, the first light emitting surface 7 may be configured to control lateral distribution of light. Specifically, the first light emitting surface 7 includes one or more optical surfaces configured to adjust the propagation direction of the light in a left-right direction. Optionally, at least a part of optical surfaces in the one or more optical surfaces included in the first light emitting surface 7 may converge light in a left-right direction; in addition, optionally, at least a part of optical surfaces in the one or more optical surfaces included in the first light emitting surface 7 may diffuse the light in a left-right direction.

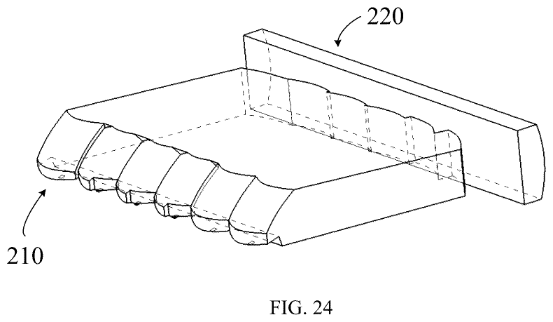

As shown in FIG. 23, a cross section of the first light emitting surface 7 may be a curved surface protruding forward, to converge the light in the left-right direction. As shown in FIG. 24 to FIG. 30, the cross section of the first light emitting surface 7 may include a plurality of optical surfaces, and one or more curved surfaces may be included in the plurality of optical surfaces. On the whole, as shown in FIG. 24 to FIG. 30, the one or more optical surfaces in the first light emitting surface may be pattern surfaces disposed according to an actual light distribution requirement. It should be noted that a plurality of pattern surfaces included in the first light emitting surface 7 of the vehicle lamp optical element do not need to be in a one-to-one correspondence with the optical unit groups 200.

In the embodiments of the specification, the first light emitting surface 7, the second light incident surface 8, and the second light emitting surface 9 may be configured to jointly control vertical distribution of the light. Specifically, at least one of the first light emitting surface 7, the second light incident surface 8, and the second light emitting surface 9 may include one or more optical surfaces configured to adjust a propagation direction of the light in an up-down direction. Optionally, at least a part of optical surfaces of the one or more optical surfaces included in at least one of the first light emitting surface 7, the second light incident surface 8, and the second light emitting surface 9 may converge the light to a certain degree in the up-down direction.

During actual application, the first light emitting surface 7 may be configured to determine a focal point of the light in the left-right direction, and more specifically, focal points of at least a part of optical surfaces included in the first light emitting surface 7 in the left-right direction may be at the joint focal plane, for example, may be near a cutoff line structure, of the optical unit group 200, to be described in the following description. The first light emitting surface 7, the second light incident surface 8, and the second light emitting surface 9 may be configured to jointly determine a focal point of the light in the up-down direction, and more specifically, focal points of at least a part of optical surfaces in the first light emitting surface 7, the second light incident surface 8, and the second light emitting surface 9 in the up-down direction may be at the joint focal plane, for example, may be near a cutoff line structure, of the optical unit group 200, to be described in the following description.

In the embodiments of the specification, the light incident surface 21, the reflecting surface 22, the first light emitting surface 7, the second light incident surface 8, and the second light emitting surface 9 may be disposed along a light path in sequence. The light incident surface 21 is close to a light source and collects light, and the reflecting surface 22 performs secondary light distribution on light emitted by the light source, so that the light is emitted to form a light shape after the light passes through the first light emitting surface 7, the second light incident surface 8, and the second light emitting surface 9 in sequence and a propagation direction of the light is adjusted. During actual application, the vehicle lamp optical element (the optical unit group 200) may form a target light shape or a part of the target light shape in a traffic space in front of a vehicle provided with a vehicle lamp module including the vehicle lamp optical element.

Referring to FIG. 7 to FIG. 16 and related descriptions, the light receiving structure 2

and the light source may be configured to be consistent with that in the embodiments described above, and details are not described herein again.

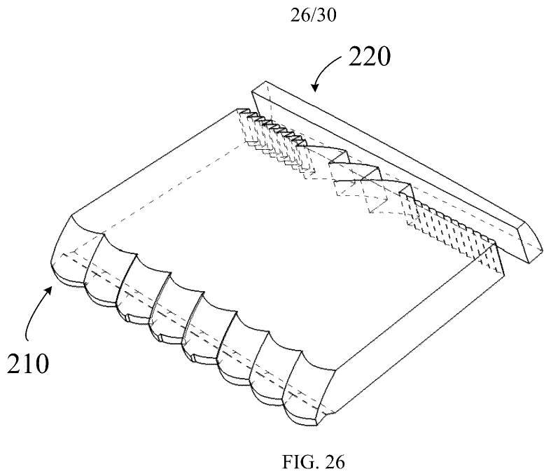

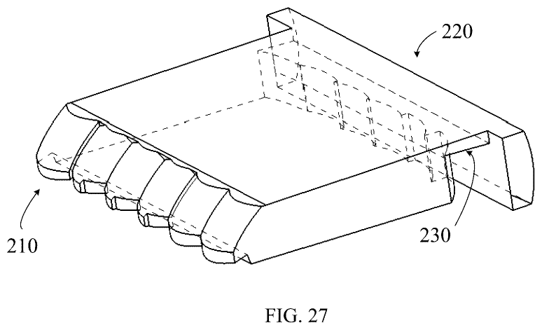

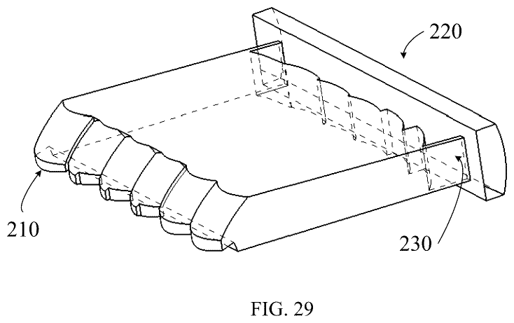

In addition, in a case that the vehicle lamp optical element includes a plurality of optical unit groups 200, optionally, the plurality of optical unit groups 200 may be integrally formed to obtain the vehicle lamp optical element; or optionally, the plurality of optical unit groups 200 may be separately formed and then spliced to obtain the vehicle lamp optical element. Specifically, in a case that the vehicle lamp optical element includes a plurality of optical unit groups 200, the plurality of optical unit groups 200 may be integrally formed or spliced according to an actual requirement. During actual application, a quantity of optical unit groups 200 actually included in the vehicle lamp optical element may be determined according to requirements of luminous flux and optical performance. For example, FIG. 24, FIG. 26, FIG. 27, and FIG. 29 show an example of an integrally formed vehicle lamp optical element including a plurality of optical unit groups 200. It may be understood that a combination manner of the plurality of optical unit groups 200 may be configured according to an actual requirement and does not need to be limited to the foregoing examples. The plurality of optical unit groups 200 may not only be combined into a lateral row style shown in FIG. 24, FIG. 26, FIG. 27, and FIG. 29, but also may be combined into various styles such as a vertical row, a C shape, and an L shape, to meet a requirement of an overall lamp style.

In addition, in the embodiments of the specification, in the optical unit group 200 shown in the accompanying drawings, although sizes of a front end and a rear end of the first optical unit 210 are generally consistent, a shape of the first optical unit 210 is not limited to the examples shown in the accompanying drawings. In addition, in the optical unit group 200 shown in the accompanying drawings, although a size of a longitudinal section of the second optical unit 220 is greater than a size of a longitudinal section of the first optical unit 210, in actual application, this should not be limited thereto, for example, sizes of longitudinal sections of the second optical unit and the first optical unit may be generally consistent, or the size of the longitudinal section of the second optical unit 220 may be less than the size of the longitudinal section of the first optical unit 210.

Based on the solutions in the embodiments of the specification, optionally, the first optical unit 210 and the second optical unit 220 in the optical unit group 200 may be separately formed and then assembled, that is, relative positions of the first optical unit 210 and the second optical unit 220 may be fixed through assembly. Alternatively, optionally, the first optical unit 210 and the second optical unit 220 may be integrally formed, and specifically, a connecting structure 230 may be formed between the first optical unit 210 and the second optical unit 220.

FIG. 27 to FIG. 30 show an example of the optical unit group 200 integrally formed by the first optical unit 210 and the second optical unit 220. In actual application, the connecting structure 230 between the first optical unit 210 and the second optical unit 220 may be formed between a first optical unit block formed by a plurality of first optical units 210 and a second optical unit block formed by a plurality of second optical units 220. More specifically, the connecting structure 230 may be formed on at least one side of an upper side, a lower side, a left side, and a right side that are between the first optical unit block and the second optical unit block.

Based on the solutions in the embodiments of the specification, compared with a conventional solution, a quantity of refracting surfaces through which light passes is reduced, and light utilization efficiency is higher. Therefore, a structure is simple and efficiency is high, and a light channel and the light emitting surface can be configured to be smaller. In addition, a focal point of each optical surface in the optical unit group 200 is located at the reflecting surface 22 or close to the reflecting surface 22, so that a length in a front-rear direction of the vehicle lamp optical element formed by the optical unit group 200 (that is, the first optical unit 210 and the second optical unit 220) is greatly reduced. Therefore, based on the vehicle lamp optical element provided in the embodiments of the specification, a smaller element size can realize a higher degree of freedom in overall lamp style design, which reduces design difficulty of an overall lamp structure and realizes an aesthetic appearance.

At present, a height of a common vehicle lamp optical assembly in the market is

usually more than 25 mm, and a height and a width of the optical unit provided in the embodiments of the specification can be within 5 mm, which is much less than a size of a conventional solution in the market. A smaller light emitting surface makes a space occupied by the vehicle lamp optical element smaller and more aesthetic, can reduce design difficulty of overall lamp structure, and realizes a higher degree of freedom in overall lamp style design.

Based on the vehicle lamp optical element (the optical unit group 200) provided in the embodiments of the specification, a light shape without a cutoff line may be provided, for example, FIG. 19. During actual application, the vehicle lamp optical element (the optical unit group 200) may be applied to a high beam.

In at least a part of the embodiments of the specification, the cutoff line structure may further be disposed in the first optical unit 210 of the optical unit group 200, to be configured to form a light shape with a cutoff line, for example, FIG. 20 and FIG. 21. During actual application, the vehicle lamp optical element (the optical unit group 200) may be applied to a high beam, a front fog lamp, a corner lamp, a steering auxiliary illumination lamp, or the like.

In the embodiments of the specification, the cutoff line structure (including a first cutoff line structure and a second cutoff line structure) may specifically refer to a structure configured to form a light shape cutoff line in a light shape.

In addition, it can be known with reference to FIG. 19 to FIG. 23 and FIG. 8 to FIG. 16 that, optionally, the light receiving structure 2 in the optical unit group 200 may further include a first cutoff line structure located on the reflecting surface 22, and the first cutoff line structure is configured to destroy a local reflection effect of the reflecting surface 22; focal points of the first light emitting surface 7 in a left-right direction are located at the first cutoff line structure; and focal points of the first light emitting surface 7, the second light incident surface 8, and the second light emitting surface 9 in an up-down direction are located at the first cutoff line structure.

Optionally, the light receiving structure 2 in the optical unit group 200 may further include a cutting surface 23 formed by cutting the reflecting surface 22, and a shape of a first boundary line 201 between the reflecting surface 22 and the cutting surface 23 is adapted to a shape of a light shape cutoff line; or optionally, the reflecting surface 22 of the light receiving structure 2 includes a first region 221 whose outer side is coated with a highly-absorbent material and a second region 222 whose outer side is coated with a highly-reflective material, and a shape of a border line 202 between the first region 221 and the second region 222 is adapted to a shape of a light shape cutoff line; or optionally, the first optical unit 210 further includes a first splicing portion 3 located at a rear end of the light receiving structure 2, the first splicing portion 3 is made of a nontransparent material, and a shape of a second boundary line 203 between a splicing interface that is formed between the first splicing portion 3 and the light receiving structure 2 and the reflecting surface 22 is adapted to a shape of a light shape cutoff line.

Optionally, the first optical unit 210 in the optical unit group 200 may further include a second cutoff line structure located downstream of the reflecting surface 22 on a light path, and the second cutoff line structure is configured to block partial light emitted from the reflecting surface 22 to the first light emitting surface 7; focal points of the first light emitting surface 7 in a left-right direction are located at the second cutoff line structure; and focal points of the first light emitting surface 7, the second light incident surface 8, and the second light emitting surface 9 in an up-down direction are located at the second cutoff line structure.

Optionally, the second cutoff line structure includes a groove 4 located in a region of a lower side surface of the first optical unit 210; and the groove 4 includes a first side surface 41 close to the light receiving structure 2 and a second side surface 42 away from the light receiving structure 2, and a shape of a third boundary line 401 between the first side surface 41 and the second side surface 42 is adapted to a shape of a light shape cutoff line.

Optionally, the first optical unit 210 further includes a second splicing portion 5 located in the groove 4, and the second splicing portion 5 is made of a nontransparent material.

Alternatively, optionally, at least one of the first side surface 41 and the second side surface 42 may be coated with a highly-absorbent material or a highly-reflective material. The highly-reflective material may include aluminum, silver, stainless steel, chromium, and the like, which is not limited thereto. The highly-absorbent material may include black paint, the black paint may include, for example, pigment (for example, carbon black, iron oxide, and titanium dioxide), solvent (for example, a desiccant, a thinner, and a preservative), and resin (for example, a desiccant, a thinner, and a preservative), and may further include additives (for example, a desiccant, a thinner, and a preservative) and the like. The example of the black paint is not limited thereto, and the example of the highly-absorbent material is not limited to the black paint. During actual application, the first side surface 41 and the second side surface 42 may not be coated with any material, and an effect of blocking the light path is implemented only through angle adjustment; and the highly-absorbent material or the highly-reflective material may further improve a light blocking effect.

Optionally, the second cutoff line structure is disposed at a position adjacent to the light receiving structure 2.

Optionally, an outer side of the reflecting surface 22 is coated with a reflective coating; or optionally, an outer side of the reflecting surface 22 is provided with a reflective mirror 6 that is adjacent to the reflecting surface 22 and that has a contour consistent with that of the reflecting surface 22.

For more related features of the cutoff line structure, corresponding descriptions in other embodiments above may be used as reference.

In embodiments of the specification, a vehicle lamp module is provided, and the vehicle lamp module includes a vehicle lamp optical element.

Optionally, the vehicle lamp optical element includes one or more optical units 100; a front end of the optical unit 100 is provided with a light emitting surface 1, a rear end thereof is provided with a light receiving structure 2, the light receiving structure 2 includes a light incident surface 21 and a reflecting surface 22, the light receiving structure 2 is configured to reflect light that is incident from the light incident surface 21 through the reflecting surface 22 and then form an intermediate light image at a focal plane of the light emitting surface 1, and the light emitting surface 1 is configured to image the intermediate light image to a front of the vehicle lamp optical element.

Alternatively, optionally, the vehicle lamp optical element includes one or more optical unit groups 200; the optical unit group 200 includes a first optical unit 210 and a second optical unit 220 that are disposed along a light path in sequence; a rear end of the first optical unit 210 is provided with a light receiving structure 2, and a front end thereof is provided with a first light emitting surface 7; a rear end of the second optical unit 220 is provided with a second light incident surface 8, and a front end thereof is provided with a second light emitting surface 9; and the light receiving structure 2 includes a light incident surface 21 and a reflecting surface 22, the light receiving structure 2 is configured to reflect light that is incident from the light incident surface 21 through the reflecting surface 22 and then form an intermediate light image at a joint focal plane of the first light emitting surface 7, the second light incident surface 8, and the second light emitting surface 9, and the first light emitting surface 7 and the second optical unit 220 are configured to image the intermediate light image to a front of the vehicle lamp optical element.

During actual application, the vehicle lamp module further includes a light source corresponding to the light receiving structure 2, the light source is fixed at the light incident surface 21 of the light receiving structure 2, and light emitted from the light source is incident inside the vehicle lamp optical element through the light incident surface 21.

In embodiments of the specification, a vehicle is provided and includes a vehicle lamp module, and the vehicle lamp module includes the vehicle lamp optical element described in the foregoing embodiments.

During actual application, the vehicle may specifically be a motor vehicle and may include but is not limited to an automobile, a motorcycle, an electromobile, a tram or a trolleybus, an agricultural transport vehicle, and the like. The present application does not specifically limit a type of the vehicle.

One or more embodiments of the specification at least can achieve the beneficial effects as follows:

First, the provided vehicle lamp optical element has a smaller light emitting surface, and a height and a width of a single optical unit may be within 5 mm. A quantity of units required for a complete function depends on used light source power and light spot performance requirements. A smaller light emitting surface makes a space occupied by the vehicle lamp optical element smaller and more aesthetic, can reduce design difficulty of overall lamp structure, and realizes a higher degree of freedom in overall lamp style design.

Second, a quantity of parts of a current common vehicle lamp module solution (for example, an integrally formed thick-wall lens implements an illumination function of the vehicle lamp module) is reduced, which not only has lower material costs, but also can reduce assembly links, reduce assembly difficulty, and improve a production speed. Meanwhile, fewer parts mean fewer component tolerances and assembly tolerances, so that stability of quality and performance of the vehicle lamp module and a vehicle lamp can be improved.

Third, when an independent optical element is integrally formed, the light emitting surface of the provided vehicle lamp optical element has more appearance possibilities. At present, in a mainstream vehicle lamp module, the light emitting surface is usually a smooth curved surface, and a frame is usually circular or flat and square. However, in the embodiments of the specification, a surface of the light emitting surface may be configured as a clathrate pattern, a horizontal stripe pattern, a vertical strip pattern, a rhombic pattern, a polygonal pattern, another special-shaped pattern, and the like, and a contour of the light emitting surface may be a whole circle, a square, a rhombus, a polygon, another special shape, and the like. In addition, the light emitting surface of the vehicle lamp optical element in the embodiments of the specification may protrude from a decorative frame or be wrapped in a decorative frame in a front-rear direction.

Fourth, when a first optical element and a second optical element are separately formed, a simple appearance of the optical element can be ensured while a specified optical function is implemented.

The above describes specific embodiments of the specification. Other embodiments are within the scope of the appended claims. The above descriptions are merely embodiments of the present application, and are not used to limit the present application. For a person skilled in the art, the present application may have various modifications and variations. Any modification, equivalent replacement, or improvement made without departing from the spirit and principle of the present application shall fall within the scope of the claims of the present application.

What is claimed is:

1. A vehicle lamp optical element, wherein the vehicle lamp optical element comprises one or more optical units (100); and a front end of the optical unit (100) is provided with a light emitting surface (1), a rear end thereof is provided with a light receiving structure (2), the light receiving structure (2) comprises a light incident surface (21) and a reflecting surface (22), the light receiving structure (2) is configured to reflect light that is incident from the light incident surface (21) through the reflecting surface (22) and then form an intermediate light image at a focal plane of the light emitting surface (1), and the light emitting surface (1) is configured to image the intermediate light image to a front of the vehicle lamp optical element; and
an outer side of the reflecting surface (22) is coated with a reflective coating; or an outer side of the reflecting surface (22) is provided with a reflective mirror (6) that is adjacent to the reflecting surface (22) and that has a contour consistent with that of the reflecting surface (22).

2. The vehicle lamp optical element according to claim 1, wherein the light receiving structure (2) further comprises a first cutoff line structure located on the reflecting surface (22), and the first cutoff line structure is configured to destroy a local reflection effect of the reflecting surface (22); and at least one focal point of the light emitting surface (1) is located at the first cutoff line structure.

3. The vehicle lamp optical element according to claim 2, wherein the light receiving structure (2) further comprises a cutting surface (23) formed by cutting the reflecting surface (22), and a shape of a first boundary line (201) between the reflecting surface (22) and the cutting surface (23) is adapted to a shape of a light shape cutoff line; or
the reflecting surface (22) of the light receiving structure (2) comprises a first region (221) whose outer side is coated with a highly-absorbent material and a second region (222) whose outer side is coated with a highly-reflective material, and a shape of a border line (202) between the first region (221) and the second region (222) is adapted to a shape of a light shape cutoff line; or
the optical unit (100) further comprises a first splicing portion (3) located at a rear end of the light receiving structure (2), the first splicing portion (3) is made of a nontransparent material, and a shape of a second boundary line (203) between a splicing interface that is formed between the first splicing portion (3) and the light receiving structure (2) and the reflecting surface (22) is adapted to a shape of a light shape cutoff line.

4. The vehicle lamp optical element according to claim 1, wherein the optical unit (100) further comprises a second cutoff line structure located downstream of the reflecting surface (22) on a light path, and the second cutoff line structure is configured to block partial light emitted from the reflecting surface (22) to the light emitting surface (1); and at least one focal point of the light emitting surface (1) is located at the second cutoff line structure.

5. The vehicle lamp optical element according to claim 4, wherein the second cutoff line structure comprises a groove (4) located in a region of a lower side surface of the optical unit (100); and the groove (4) comprises a first side surface (41) close to the light receiving structure (2) and a second side surface (42) away from the light receiving structure (2), and a shape of a third boundary line (401) between the first side surface (41) and the second side surface (42) is adapted to a shape of a light shape cutoff line.

6. The vehicle lamp optical element according to claim 5, wherein the optical unit (100) further comprises a second splicing portion (5) located in the groove (4), and the second splicing portion (5) is made of a nontransparent material;
or
at least one of the first side surface (41) and the second side surface (42) is coated with a highly-absorbent material or a highly-reflective material.

7. The vehicle lamp optical element according to claim 5, wherein the second cutoff line structure is disposed at a position adjacent to the light receiving structure (2).

8. A vehicle lamp optical element, wherein the vehicle lamp optical element comprises one or more optical unit groups (200); the optical unit group (200) comprises a first optical unit (210) and a second optical unit (220) that are disposed along a light path in sequence; a rear end of the first optical unit (210) is provided with a light receiving structure (2), and a front end thereof is provided with a first light emitting surface (7); a rear end of the second optical unit (220) is provided with a second light incident surface (8), and a front end thereof is provided with a second light emitting surface (9); and the light receiving structure (2) comprises a light incident surface (21) and a reflecting surface (22), the light receiving structure (2) is configured to reflect light that is incident from the light incident surface (21) through the reflecting surface (22) and then form an intermediate light image at a joint focal plane of the first light emitting surface (7), the second light incident surface (8), and the second light emitting surface (9), and the first light emitting surface (7) and the second optical unit (220) are configured to image the intermediate light image to a front of the vehicle lamp optical element; and
an outer side of the reflecting surface (22) is coated with a reflective coating; or an outer side of the reflecting surface (22) is provided with a reflective mirror (6) that is adjacent to the reflecting surface (22) and that has a contour consistent with that of the reflecting surface (22).

9. The vehicle lamp optical element according to claim 8, wherein the first light emitting surface (7) is configured to control lateral distribution of light.

10. The vehicle lamp optical element according to claim 9, wherein the first light emitting surface (7) comprises one or more optical surfaces configured to adjust a propagation direction of the light in a left-right direction.

11. The vehicle lamp optical element according to claim 9, wherein the first light emitting surface (7), the second light incident surface (8), and the second light emitting surface (9) are configured to jointly control vertical distribution of the light.

12. The vehicle lamp optical element according to claim 11, wherein at least one of the first light emitting surface (7), the second light incident surface (8), and the second light emitting surface (9) comprises one or more optical surfaces configured to adjust a propagation direction of the light in an up-down direction.

13. The vehicle lamp optical element according to claim 8, wherein the first optical unit (210) and the second optical unit (220) are integrally formed.

14. The vehicle lamp optical element according to claim 13, wherein a connecting structure (230) is formed between the first optical unit (210) and the second optical unit (220).

15. The vehicle lamp optical element according to claim 8, wherein the light receiving structure (2) further comprises a first cutoff line structure located on the reflecting surface (22), and the first cutoff line structure is configured to destroy a local reflection effect of the reflecting surface (22); focal points of the first light emitting surface (7) in a left-right direction are located at the first cutoff line structure; and focal points of the first light emitting surface (7), the second light incident surface (8), and the second light emitting surface (9) in an up-down direction are located at the first cutoff line structure.

16. The vehicle lamp optical element according to claim 15, wherein the light receiving structure (2) further comprises a cutting surface (23) formed by cutting the reflecting surface (22), and a shape of a first boundary line (201) between the reflecting surface (22) and the cutting surface (23) is adapted to a shape of a light shape cutoff line; or the reflecting surface (22) of the light receiving structure (2) comprises a first region (221) whose outer side is coated with a highly-absorbent material and a second region (222) whose outer side is coated with a highly-reflective material, and a shape of a border line (202) between the first region (221) and the second region (222) is adapted to a shape of a light shape cutoff line; or
the first optical unit (210) further comprises a first splicing portion (3) located at a rear end of the light receiving structure (2), the first splicing portion (3) is made of a nontransparent material, and a shape of a second boundary line (203) between a splicing interface that is formed between the first splicing portion (3) and the light receiving structure (2) and the reflecting surface (22) is adapted to a shape of a light shape cutoff line.

17. The vehicle lamp optical element according to claim 8, wherein the first optical unit (210) further comprises a second cutoff line structure located downstream of the reflecting surface (22) on a light path, and the second cutoff line structure is configured to block partial light emitted from the reflecting surface (22) to the first light emitting surface (7); focal points of the first light emitting surface (7) in a left-right direction are located at the second cutoff line structure; and focal points of the first light emitting surface (7), the second light incident surface (8), and the second light emitting surface (9) in an up-down direction are located at the second cutoff line structure.

18. The vehicle lamp optical element according to claim 17, wherein the second cutoff line structure comprises a groove (4) located in a region of a lower side surface of the first optical unit (210); and the groove (4) comprises a first side surface (41) close to the light receiving structure (2) and a second side surface (42) away from the light receiving structure (2), and a shape of a third boundary line (401) between the first side surface (41) and the second side surface (42) is adapted to a shape of a light shape cutoff line.

19. The vehicle lamp optical element according to claim 18, wherein the first optical unit (210) further comprises a second splicing portion (5) located in the groove (4), and the second splicing portion (5) is made of a nontransparent material;
or
at least one of the first side surface (41) and the second side surface (42) is coated with a highly-absorbent material or a highly-reflective material.

20. The vehicle lamp optical element according to claim 18, wherein the second cutoff line structure is disposed at a position adjacent to the light receiving structure (2).
